(19) United States
(12) Patent Application Publication
(10) Pub. No.: US 2012/0047156 A1
(43) Pub. Date: Feb. 23, 2012

(54) Method and Apparatus for Identifying and Mapping Content

(75) Inventors: Jussi Tapio JARVINEN, Tampere (FI); Jari Petteri JOKINEN, Velaatta (FI); Sergey GERASIMENKO, Espoo (FI); Sotiris MAKRYGIANNIS, Helsinki (FI)

(73) Assignee: NOKIA CORPORATION, Espoo (FI)

(21) Appl. No.: 12/909,680

(22) Filed: Oct. 21, 2010

Related U.S. Application Data
(60) Provisional application No. 61/374,841, filed on Aug. 18, 2010.

(51) Int. Cl. G06F 15/16; G06F 17/30

(52) U.S. Cl. 707/758; 709/217; 707/E17.005

(57) ABSTRACT

An approach is provided for identifying and mapping content. A content mapping platform receives a sample of content and determines to identify the content based, at least in part, on the sample. The content mapping platform then determines to initiate transfer of the content, information related to the content, other content related to the content, a preview of the content, or a combination thereof to a device based, at least in part, on the identification.

### RELATED APPLICATION

This application claims the benefit of the earlier filing date under 35 U.S.C.§119 of U.S. Provisional Application Ser. No. 61/374,841 filed Aug. 18, 2010 entitled, “METHOD AND APPARATUS FOR IDENTIFYING AND MAPPING CONTENT” the entirety of which is incorporated herein by reference.

### BACKGROUND

Service providers (e.g., wireless, cellular, etc.) and device manufacturers are continually challenged to deliver value and convenience to consumers by, for example, providing compelling network services. One area of development has been services and applications related to generating and consuming content (e.g., music, video, electronic books, files, documents, etc.) on one or more user devices. This development has resulted in an explosion of content available to users including media content delivered as content streams. For example, it is not uncommon for a user of modern media services to have access to several million or more media content items, including hundreds or thousands content or live content streams (e.g., live broadcasts of video and/or audio programs), at any given time. Further, a user may need to and/or decide to continue content consumption on different devices and/or at different times. The vast extent of available content can easily overwhelm the user, thereby making it difficult for a user to discover and locate content of interest to the user. Moreover, content may be available from any number of sources (e.g., content providers, distributors, advertisers, shared content, etc.) corresponding to various locations (e.g., store fronts, event venues, radio or television stations, storage devices, user devices, etc.). Therefore, service providers and device manufactures face significant technical challenges to enable users to sift through the volume of available content and discover media (e.g., content streams) of potential interest.

### SOME EXAMPLE EMBODIMENTS

Therefore, there is a need for an approach for efficiently identifying and mapping content or content streams to facilitate, for instance, easy access to available content.

According to one embodiment, a method comprises receiving a sample of content. The method also comprises determining to identify the content based, at least in part, on the sample. The method further comprises determining to initiate transfer of the content, information related to the content, other content related to the content stream, or a combination thereof to a device based, at least in part, on the identification.

According to another embodiment, an apparatus comprising at least one processor, and at least one memory including computer program code, the at least one memory and the computer program code configured to, with the at least one processor, cause, at least in part, the apparatus to receive a sample of content. The apparatus also caused to determine to identify the content based, at least in part, on the sample. The apparatus is further caused to determine to initiate transfer of the content, information related to the content, other content related to the content, or a combination thereof to a device based, at least in part, on the identification.

According to another embodiment, a computer-readable storage medium carrying one or more sequences of one or more instructions which, when executed by one or more processors, cause, at least in part, an apparatus to receive a sample of content. The apparatus also caused to determine to identify the content based, at least in part, on the sample. The apparatus is further caused to determine to initiate transfer of the content, information related to the content, other content related to the content, or a combination thereof to a device based, at least in part, on the identification.

According to another embodiment, an apparatus comprises means for receiving a sample of content. The apparatus also comprises means for determining to identify the content based, at least in part, on the sample. The apparatus further comprises means for determining to initiate transfer of the content, information related to the content, other content related to the content stream, or a combination thereof to a device based, at least in part, on the identification.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of identifying and mapping content, according to an embodiment;

FIG. 2 is a diagram of the components of a content mapping platform, according to an embodiment;

FIG. 3 is a flowchart of a process for identifying and mapping content, according to an embodiment;

FIG. 4 is a flowchart of a process for generating a database of content samples for identifying and mapping content, according to an embodiment;

FIGS. 5A-5D are diagrams of user interfaces utilized in the processes of FIGS. 3 and 4, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for identifying and mapping content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

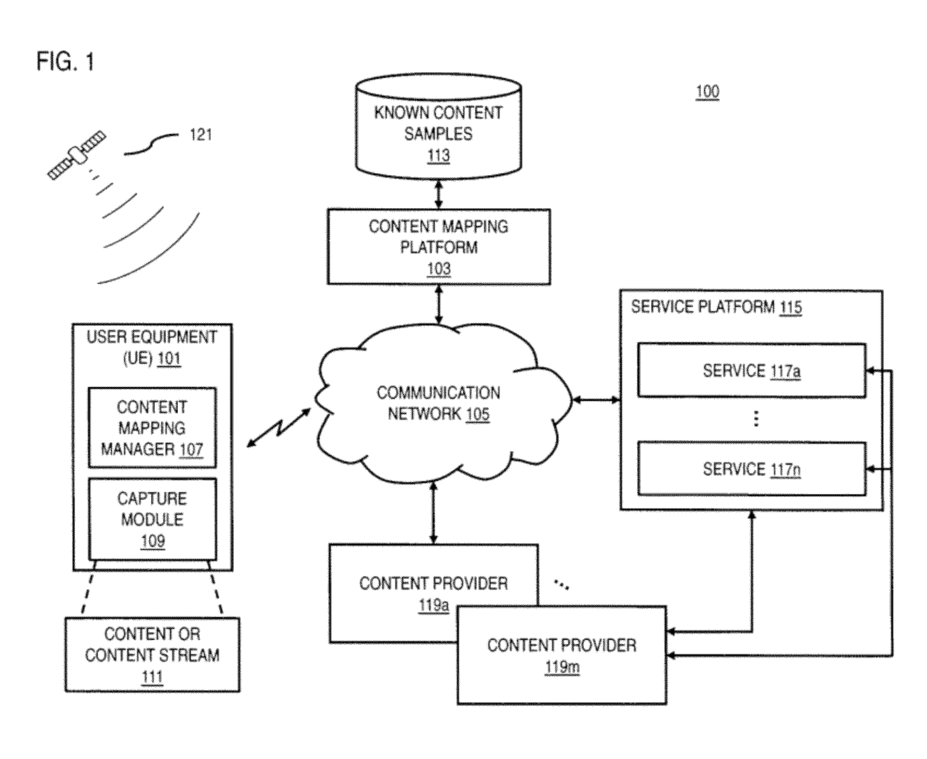

FIG. 1 is a diagram of a system capable of identifying and mapping content, according to an embodiment. As discussed previously, it is noted that modern content services offer a vast collection of content over, for instance, the Internet and other sources (e.g., broadcasts, content streams, cloud computing, peer devices, etc.). As used herein, the term content includes media and/or user content that are transmitted over a communication network, a broadcast network, and/or other content delivery network. In addition, the content may be provided as a content stream that is constantly and/or continuously received and presented at a user device. Further, the content may be created and/or saved on one or more user devices by one or more users. By way of example, the content stream may be either a live broadcast stream or a previously stored stream that is provided on demand. In another example, the content (e.g., a text document, data document, file, etc.), may be created by one or more users, stored at one or more storage devices (e.g., storage devices in cloud computing) and/or one or more user devices, and accessed by one or more users. This vast collection of available content can quickly overwhelm the user, thereby making it extremely difficult for the user to discover, identify, and/or access content of interest. For example, some conventional or traditional approaches to discovering content are by browsing or searching websites, service directories, receiving recommendations, synching with another device, and the like, to find content of interest. However, it is noted that these conventional approaches have been commonly and ubiquitously used in many of such content services. Accordingly, the user may find the traditional methods for finding content uninteresting, and therefore, may be discouraged from using these services. Without an exciting, easy to use or novel presentation, content that would otherwise appeal to the user might go unnoticed and be missed.

To address this problem, a system 100 of FIG. 1 introduces the capability to capture or otherwise receive a sample of content, identify the content based on the sample (e.g., by applying recognition algorithms to the sample), map the identified content to a content source, and then initiate transfer of the recognized content to a user device from the content source. In one sample use case, the system 100 enables a user equipment (UE) 101 to capture a sample of media content that is currently playing within vicinity of the UE 101. For instance, if the user is nearby a television that is currently playing a program of interest, the user can initiate sampling of the program using the UE 101's onboard video and/or audio recorders. By way of example, the sample can be an audio, video, or image sample of varying lengths (e.g., a single image of a currently playing video, a short video with audio of the currently playing video, etc.).

Further, in the system 100, internet-based computing and/or storage (cloud computing) can be utilized. Cloud computing is referred to internet-based computing, whereby shared resources, software, applications and information are provided to computers and other devices on demand. In another sample use case, a user is utilizing a content (e.g., a document, a file, etc.); which is, at least, synchronized/stored at a cloud computing storage device; on a first user device (e.g., a personal computer, PC) and wants to continue utilizing the same content on a different device, for example UE 101 (e.g., a mobile phone). Currently, several steps could be required to accomplish this task. For example, the user would have to connect the UE 101 to the first device, locate the content of interest on the first device, transfer the content to the UE 101, locate the content on UE 101, locate an appropriate application for the content and then continue utilizing the content on the UE 101. However, utilizing cloud computing and/or cloud storage and, at least, optical character recognition (OCR) technology, these steps can be reduced and substantially automated. For example, when the user decides to transfer utilization of the content from the first device to a different device, such as UE 101, the user can capture a sample (e.g., by utilizing a camera on UE 101) of the content displayed on the first device. One or more applications on UE 101 perform steps to capture and transmit one or more samples of the content.

In another embodiment, one or more users wish to utilize/share one or more content available in the cloud computing. For example, one or more users utilize the same content in a group, in a project, and the like. The sharing may be performed using the processes described herein with respect to capturing a sample of the content, identifying the content, and then initiating transfer of the identified content.

In one embodiment, the system 100 can then compare the sample against a library, list or database of known and/or stored content clips to identify the content. In some embodiments, a service provider may create the database of known content clips by continuously sampling one or more available programming sources (e.g., live streaming broadcasts). In other embodiments, the system 100 can conduct a search over the Internet or other data network for one or more of the recognized characteristics of the sample. In another embodiment, the sample is compared to list of content on one or more predetermined storage devices on, for example, public and/or private networks utilizing cloud computing. Once identified, the system 100 can map the sampled content to one or more content sources to determine a location (e.g., a Uniform Resource Locator (URL)) of the content. Next, the system 100 initiates transfer of the content (e.g., as a content stream) to the UE 101. In this way, a user can direct the UE 101 to capture a sample content of interest from, for instance, a radio or television, a PC, and then receive a stream of the sampled content, a link to the content, and/or the entire content at the UE 101 so that the user can continue to consume/utilize the content on the UE 101 even when the user no longer is near the television, radio, the PC and the like.

In another embodiment, the captured sample is of a text and/or a data document displayed on a user device. The content information in the sample, such as text and/or data, is used to find a potentially matching content and upon receiving the content at UE 101, the content is displayed at substantially same progress point as indicated by the captured sample. For example, if the captured sample is of page three and lines 5-15 of a document, then the received content at the UE 101 is displayed at page three and lines 5-15. In another example, on the UE 101 more of the received content is displayed; however, the progress point is, at least, visibly indicated such as with a cursor, a pointing device maker, highlights, textual effects, and the like. The progress point can also be indicated as a point for the user of the UE 101 to resume content utilization/consumption.

In another embodiment, the captured sample is compared to content available on another user device. For example, a first user device (e.g., UE101a), captures the sample from a second user device (e.g., UE101b), then the first user device connects to the second user device (e.g., via wired and/or wireless methods), directly or via a communications network (e.g., a local area network), searches for the content, identifies the content, and obtains the content from the second user device. In another embodiment, the sample captured by the user device (e.g., a first user device UE101a) is compared to content available on the same user device (e.g., the first user device UE101a). For example, the UE101a can already contain content potentially matching the captured sample and/or have links to location of the content potentially matching the captured sample.

In another embodiment, UE 101 is prompted to obtain a required application to utilize a requested content. For example, UE 101 requests and receives a specific content, but does not have one or more required applications in order to utilize the content; in this case, the system 100 prompts the user of UE 101 to obtain the required one or more applications.

In another embodiment, the UE 101 can also capture additional context information associated with the sample, the content, and/or the UE 101 itself. For example, the UE 101 can capture time-stamp information, location information, user information, and/or the like along with the sample to facilitate identification of the sample. For example, Global Positioning System (GPS) receivers may determine location information based on signals from GPS satellite 121. More specifically, the location information can be determined by a triangulation system such GPS, Assisted-GPS (A-GPS), Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. In addition or alternatively, the UE 101 may obtain location information using network information such a mobile network code (MNC), mobile country code (MCC), and the like. By way of example, the network information can be mapped to a known geographical location associated to determine location information. The context information may also be captured using various other physical, environmental, and other sensors (e.g., accelerometers, gyroscopes, thermometer). The context information may also be provided by the service platform 115 (e.g., a calendar service, weather service, etc.) and/or the content providers 119a-119m. In this way, the system 100 can narrow the set of potentially matching content against which to compare the sample by using the context information to assist in making the identification of the sample.

In yet another embodiment, the system 100 can use context information associated with the UE 101 and/or a corresponding user to determine the form of the identified content to transfer to the UE 101. For example, if context information (e.g., information from an accelerometer, speed sensor, location sensor, etc.) indicates that user is traveling at a high rate of speed, the system 100 may initiate transfer of the content as an audio stream rather than a video stream to avoid distracting the user.

In some embodiment, the system 100 can determine a list of available content (e.g., a list of local television and/or radio services) based on the context information and/or location information. The UE 101 and/or user may then select content from this list of available services. In one embodiment, the selection can be made by capturing or sampling at least a portion of the content that is currently playing within vicinity of the UE 101.

As shown in FIG. 1, the system 100 comprises the UE 101 having connectivity to a content mapping platform 103 via a communication network 105. In one embodiment, the content mapping platform 103 performs the identification, mapping, and initiation of the transfer of identified content as described herein. In addition or alternatively, the UE 101 may execute a content mapping manager 107 to perform all or a portion of the functions of the content mapping platform 103. By way of example, the content mapping platform 103 and/or content mapping manager 107 interacts with the capture module 109 to capture or otherwise receive a sample of a content or content stream 111. In one embodiment, the content stream 111 is any currently playing content (e.g., music playing on a radio, video playing on a television, etc.). In another embodiment, the content 111 is any content (e.g., text/data documents, etc.) currently displayed on a user device. The content mapping platform 103 can then identify the sample by, for instance, comparing the sample against a database 113 of known content samples. Based on the identification, the content mapping platform 103 can map or determine a source/location of the identified content. In one embodiment, the content includes live media (e.g., streaming broadcasts), stored media (e.g., stored on a network or locally), metadata associated with media, text information, location information of other user devices, mapping data, geo-tagged data (e.g., indicating locations of people, objects, images, etc.), stored files, or a combination thereof.

In one embodiment, the source of the content items available for user access may be the service platform 115, the one or more services 117a-117n of the service platform 115, the one or more content providers 119a-119m, and/or other content services available over the communication network 105. For example, a service 117a (e.g., a music or video service, a file service, etc.) may obtain content (e.g., media content) from a content provider 119a to deliver content to the UE 101. In one embodiment, the content mapping platform 103 may map the identified content to the content source (e.g., services 117a-117n, content providers 119a-119m), information related to the content (e.g., programming information or description), other content related to the content (e.g., similar content, alternate versions of the content, etc.), or a combination thereof. As another example, the content transferred to the UE 101 may be an advertisement or descriptive media about the identified content. For instance, a grocery store may make media (e.g., audio and/or video) available over a media hotspot that describes ongoing special sales or discounts, or a museum may make media available to describe current exhibits. A nearby user with a UE 101 that samples related content for identification can then be presented with this advertising media as related content.

In one embodiment, the system 100 can perform different actions with respect to the content depending on, for instance, context information associated with the sample, the content, and/or the UE 101 (e.g., the length of time the user samples a particular content, the user's location or time of sampling). For example, if the context information (e.g., audio input from a microphone) indicates that the user is in a noisy environment, audio content may be downloaded to the UE 101 for later access rather than streamed live to the UE 101. In one embodiment, these actions include initiating sharing of the identified content with other UEs 101 and their corresponding users. By way of example, the sharing may be initiated over one or more social networking services and/or other media sharing services (e.g., video sharing services such as Qik.com, youtube.com, etc.).

In another embodiment, the system 100 may enforce authorization features (e.g., user registration and/or password) to access available content. More specifically, the system 100 can determine whether the user has access rights to the requested content (e.g., access to premium and/or paid content). By way of example, these access rights may be available for purchase, subscription, etc. from the media service 117a. In some cases, if the user does not have access rights, the system 100 may provide limited access to the media (e.g., offer a preview of the content or direct the user to the service 117a to obtain the rights). As one example, when the user captures a sample on the UE 101 representing a requested content item, a corresponding media/application store (e.g., Nokia's Ovi store) client can be opened or executed to acquire the item. On execution of the media/application store client, the user's account can be charged for the identified content. If needed, the content is also downloaded or otherwise transferred to the UE 101. Thus, to support this capability, the UE 101 (e.g., via the content mapping manager 107) can have an interface which links to the corresponding media/application store. More specifically, the media/application store receives information regarding the identified content so that store can select the media from the store. The user can then either accept or deny the downloading of the content. In one embodiment, the media downloading is represented in the user interface to show transfer of the content from the icon to the device's memory. In addition or alternatively, the user can use drag-and-drop gestures or the like to initiate a request to transfer the media to the memory of the UE 101.

Therefore, the capabilities of the system 100 enable the user to rely on the UE 101 to sample, identify, map, and then initiate the transfer of content that may be available for user access. An advantage of the approach described herein is that a user can easily locate content based on what content is currently within the user's vicinity, thereby reducing the steps for searching and retrieving such content using traditional means. Moreover, by mapping content based on acquired samples, the user gets a feeling of being immersed within the surrounding environment that is populated or “alive” with media and/or other types of content. In other words, as the user enters locations where content is available and can be sampled for identification and transfer (e.g., a music store, an opera house a concert hall, an office, a library), and becomes curious about the content associated, the user may quickly discover and access related content and information using the embodiments of the invention. In one scenario, a user captures a sample of a content stream by taking a picture of a live source (e.g., a television program or radio program). This content is sent to the content mapping platform 103 with context information such as the time stamp of the sample. In one embodiment, the content mapping platform 103 is continuously sampling a portion of current live broadcasts. In one embodiment, the content mapping platform 103 stores only a small portion (e.g., only the last 10 seconds of a program) for potentially matching, the amount of data needed for content identification and mapping can be limited. By way of example, a sample that is a picture of a television screen is compared against the samples of known content stored by the platform 103. If a similar potential match is found, the content mapping platform 103 can transmit a streaming link to the user's device so that the program can be accessed directly at the device. Similarly, if the sample is a short video or audio clip from the radio or television, that clip can be sent to the content mapping platform 103 for identification and mapping. Then, if a potential match is found radio or video streaming can be initiated at the device.

In another scenario, a user captures a sample of content by taking a picture of the content at a source device (e.g., a PC display, a mobile device display, etc.). Further, the content is also stored at a storage device in a cloud computing storage device. The sample content is sent to the content mapping platform 103 with context information such as time stamp of the sample, user information, content name (of a document), title (of a document), subject (of a document) user location, icon representing the content, and the like. By way of example, a sample that is a picture of a user device display is compared against the samples of known content stored by the platform 103. If a similar potential match is found, the content mapping platform 103 can transmit a link to the user's device UE 101 so that the content can be accessed directly and/or a copy of the content (e.g., a document) can be sent to UE 101. In another embodiment, the mapping platform 103 and/or the UE 101 search user content access history to determine if a potential match exists.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

As noted above, the UE 101 may include the content mapping manager 107 that operates in place of or in coordination with the content mapping platform 103. In one embodiment, the content mapping manager 107 and/or the content mapping platform 103 is capable of handling various operations related to media playback and communication of media using the UE 101. For example, the content mapping manager 107 may manage incoming or outgoing media via the UE 101, and display such communication. In one embodiment, the content mapping manager 107 provides a user interface showing representations of media content items received based on the identification and mapping of media samples. Further, the content mapping manager 107 and/or content mapping platform 103 may include interfaces (e.g., application programming interfaces (APIs)) that enable the user to communicate with Internet-based websites or to use various communications services (e.g., e-mail, instant messaging, text messaging, etc.) of the UE 101 for delivery and/or management of media content. In some embodiments, the content mapping manager 107 may include a user interface (e.g., graphical user interface, audio based user interface, etc.) to access Internet-based communication services or communication networks in order to find sources of the media and access the media from the sources.

The service platform 115, services 117a-117n, and/or content providers 119a-119m may provide media content such as music, videos, television services, etc. such that the UE 101 can access the media content via the communication network 105. Thus, the service platform 115, services 117a-117n, and/or content providers 119a-119m may provide media data transfer service, media stream service, radio broadcasting service and television broadcasting service, and may further provide information related to the media content. Each of the services 117a-117n, for instance, may provide different media content and different types of media services. The media service 117a may also provide locations (e.g., URLs or other local or network addresses) of the media content and information (e.g. artist name, genre, release date, etc.) related to the media content such that the UE 101 can access this information via the communication network 105. In addition, the service platform 115, services 117a-117n, and/or content providers 119a-119m may provide a media purchase service that allows a user to purchase certain media content to download or to stream.

By way of example, the UE 101, the content mapping platform 103, the service platform 115, and the content providers 119a-119m communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the content mapping manager 107 and the content mapping platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

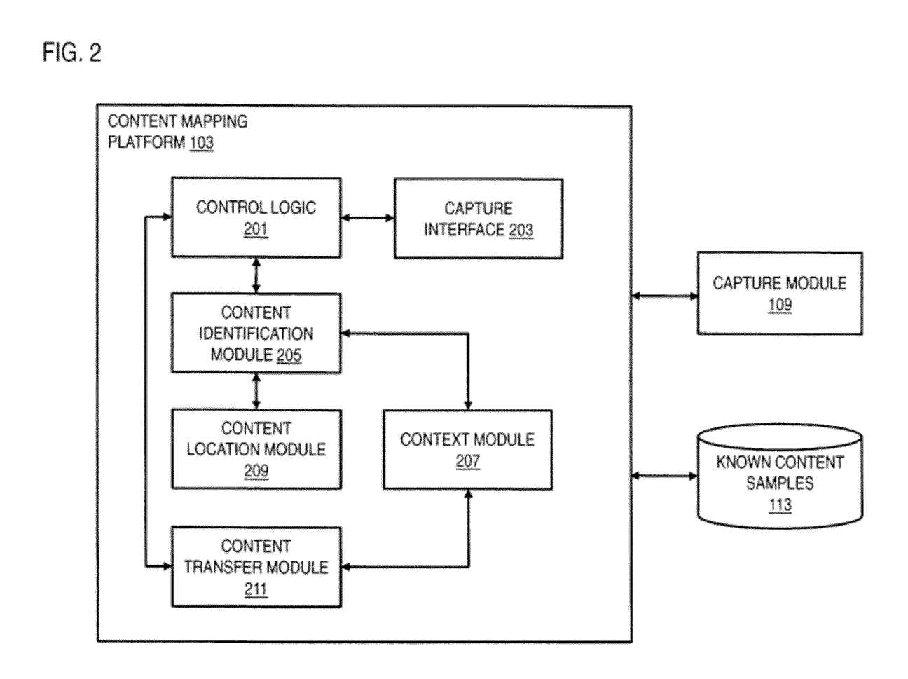

FIG. 2 is a diagram of the components of a content mapping platform, according to an embodiment. By way of example, the content mapping platform 103 includes one or more components for identifying and mapping content or content streams. It is contemplated that the functions of these components may be combined in one or more components or performed by other components of equivalent functionality. In this embodiment, the content mapping platform 103 includes at least a control logic 201 which executes at least one algorithm for performing functions of the content mapping platform 103. For example, the control logic 201 interacts with a capture interface 203 to initiate capturing and/or receipt of content samples from, for instance, the capture module 109 of the UE 101. More specifically, the capture interface 203 facilitates communication of commands and/or data between the content mapping platform 103 and the capture module 109. By way of example, the capture module 109 may include a microphone, camera, or other recording instrument or sensor for capturing content samples from media playing or otherwise available within proximity to the UE 101. As noted earlier, the capture module 109 can record video, audio, and/or individual images. It is contemplated that the samples can be of any length or duration. Furthermore, the capture module 109 can capture individual samples (e.g., one image) or a sequence of samples over time.

After receiving a content sample via the capture interface 203, the control logic 201 interacts with the content identification module 205 to identify the content sample. In one embodiment, the content identification module can employ any combination of audio-based and/or image-based recognition algorithms to identify potential matches of the content sample. For example, using one audio-based identification or recognition algorithm, the content identification module 205 may calculate a unique audio signature based on measured audio characteristics (e.g., frequency, amplitude, etc.) of the sample for comparison against known audio signatures (e.g., stored in the database 113 of known content samples. The comparison can then be used to identify one or more potentially matching candidates. Similarly, when dealing with image-based recognition, the content identification module 205 may construct a visual signature based on identified features, relative distances between the features, etc. to uniquely identify an image or video sequence. It is contemplated that the content identification module 205 may employ any algorithm known in the art to recognize and/or identify content samples.

In one embodiment, the content identification module 205 may use context information obtained from, for instance, the context module 207 to improve or facilitate identification of the sample. In some embodiments, the context module 207 may determine and/or initiate capture of context information associated with the sample, the UE 101, or other related users or components. This context information may be provided by one or more sensors of the capture module 109, other available services (e.g., services 117a-117n), or other sensors of the UE 101. More specifically, the content identification module 205 may use context information (e.g., a time stamp, location, etc.) to narrow the number of potentially matching content samples. For example, if a sample of a live broadcast or content stream is associated with a time stamp, the content identification module 205 can query the database 113 of known content samples for only those samples of content that were broadcast or streamed at a time at least approximately near the time indicated by the time stamp. Similarly, if additional context information (e.g., location) is used in conjunction or alternatively with other context information, the potentially matching samples can be further refined.

In another embodiment, if the content identification module 205 cannot determine any potentially matching candidates from the database 113 or otherwise does not have access to the database 113, the module 205 may attempt to parse the sample for terms or other meta-data. The module 205 may then perform a search (e.g., via one or more Internet-based search engines) to identify the content sample. If potential matches are still not found, the content identification module 205 may alert the user and/or request additional or alternate samples.

Following identification of the sample, the control logic 201 directs the content location module 209 to determine a source or location of the identified content. In one embodiment, the location of identified content may be specified by a URL or other network identifier. To map the location, the content mapping module 209 may, for instance, query the service platform 115, the services 117a-117n, the content providers 119a-119m, or any other content source available at the UE 101 or over the communication network 105. In addition or alternatively, the content mapping module 209 may map the identified content to information related to the content (e.g., programming information or description), other related content (e.g., similar programs, advertising information, etc.), or any combination thereof.

On obtaining the location information of the identified content, the control logic 201 interacts with the content transfer module 211o initiate transfer of the content or other related information or content from the source location to the UE 101. In one embodiment, the transfer is initiated by transmitting a streaming link to the UE 101. In addition or alternatively, the transfer may occur by direct download or transfer of the content to the UE 101. In certain embodiments, the content transfer module 211 can retrieve or request context information about the receiving UE 101 from the context module 207. Based on the context information, the content transfer module 211 may determine the type of transfer to initiate (e.g., streaming vs. download) as well as the form of transfer (e.g., audio only if the context information indicates a user might be driving, or full audio and video if the user is at rest).

In another embodiment, the content transfer module 211 may provide information for the UE 101 to set up communication with the source of the media (e.g., the service platform 115). This communication can then support transfer of content from the media source to, for instance, the UE 101. By way of example, the UE 101 may establish communication sessions with the media source using various forms of communication. For example, the UE 101 can support direct communications (e.g., peer to peer), short-range communications (e.g., WiFi, Bluetooth, etc.), communication over the network 105 (e.g., cellular, wireless, LAN, etc.) for transferring media and related information. In certain embodiments, the content transfer module 211 also provides an authentication feature to enable communication between the UE 101 and the source of the media only if there is proper authorization (e.g., credentials to access premium or paid content). The UE 101 may also be connected to data storage media such that the content transfer module 211 can access locally stored and/or cached media or content data.

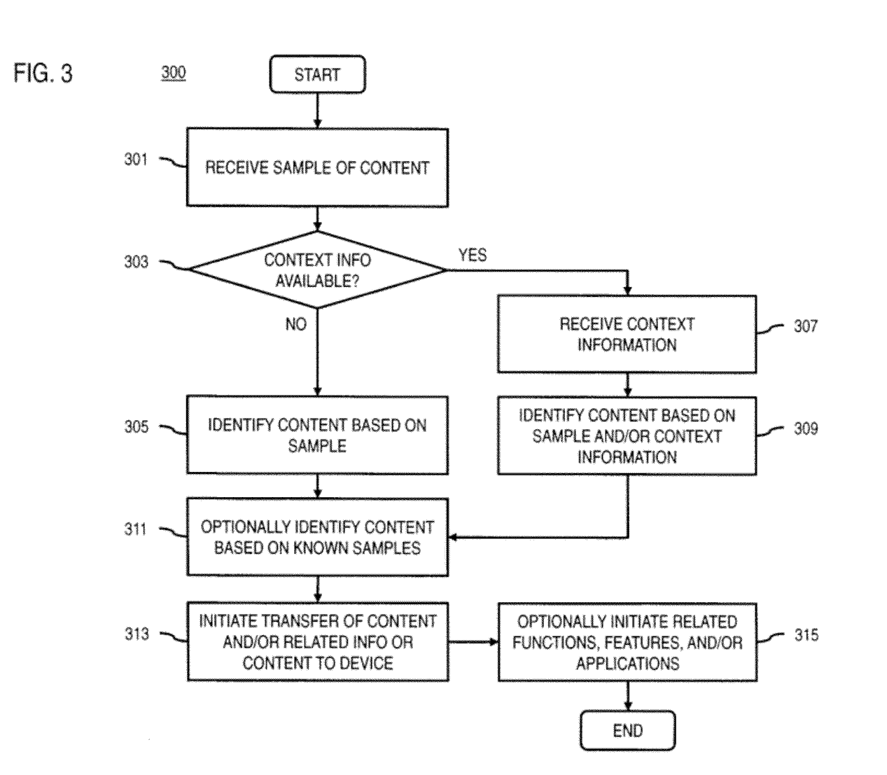

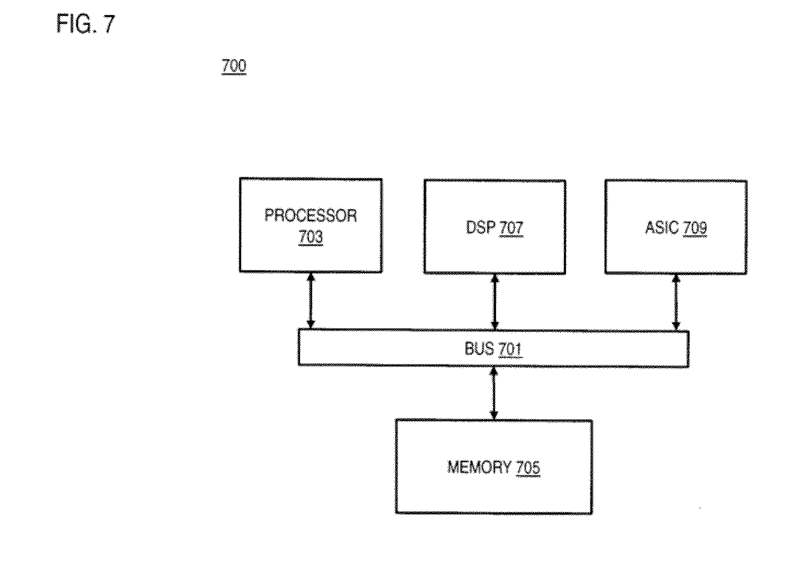

FIG. 3 is a flowchart of a process for identifying and mapping content, according to an embodiment. In one embodiment, the content mapping platform 103 performs the process 300 and is implemented in, for instance, a chip set including a processor and a memory as shown FIG. 7. In addition or alternatively, the content mapping manager 107 may perform all or a portion of the process 300. In step 301, the content mapping platform 103 receives a sample of content that has been, for instance, captured at a device (e.g., the UE 101). As described previously, in one embodiment, the sample represents content (e.g., a live broadcast or content stream) that is currently being played within vicinity of the UE 101. For example, a user hears audio content (e.g., a song) on a radio or video content (e.g., a video program) on a television and decides to initiate the content identification and mapping process as described herein by capturing a sample of the song or video program. This sample is then transmitted or otherwise conveyed to the content mapping platform 103 and/or the content mapping manager 107 (herein after, a reference to the content mapping platform 103 indicates a reference to the content mapping platform 103 and/or the content mapping manager 107). In another embodiment, the sample represents content (e.g., a document or data file) that is displayed on screen of a second user device (e.g., a PC or a mobile device). For example, a user is utilizing a document file, such as a text file, on a PC and decides to continue the utilization on another user device UE 101 and initiates the content identification and mapping process as described herein by capturing a sample of the document file. This sample is then transmitted or otherwise conveyed to the content mapping platform 103 and/or the content mapping manager 107. Next, the content mapping platform 103 determines whether context information (e.g., a time stamp, location, user activity, user preferences, user content history, user information, content title, content name, content subject, time of the day, day of the week, etc.) is available to accompany the sample (step 303). In one embodiment, the context information may be related to the sample, the content that has been sampled, the user device, or a combination thereof. For example, context related to the sample may include the time, location, sample type (e.g., audio, image, video, text, etc.), content name, and the like. Similarly, context information related to the content itself may also include a time, location, medium (e.g., radio, television, photograph, PC display, etc.), etc. Further, context information related to the device may include device capability (e.g., audio/video playback capabilities), content history at the device, content preferences specified at the device, activities being performed at the device (e.g., use of one or more other applications). In another embodiment, context information such as user location, time of the day and day of the week indicate most likely content and location of the content for the system 100 to search for. For example, if user location is at user's office, it's late afternoon on a workday, it is a high probability that the content sample is work related which can be found at one or more certain locations on the network (in cloud computing).

If no context information is available (step 305), the content mapping platform 103 determines to identify the sample content based solely on the sample. In one embodiment, the identification of the sample includes parsing the sample to determine search terms, keywords, genre, or other identifying characteristics. The content mapping platform 103 may then use the results of the parsing to conduct a general search (e.g., using Internet search engines) to identify the sample. If context information is available, the content mapping platform 103 receives the context information (step 307) and determines to identify the captured content based, at least in part, on the sample and/or the context information as described with respect to FIG. 2 (step 309). In one embodiment, the content mapping platform 103 can use all or any combination of the different types of context information to assist in the identification and mapping of the content sample. More specifically, the context information provides additional data that the content mapping platform 103 can use to identify the sample with more certainty and/or accuracy. In some cases, the context information can be used to filter or narrow the potential pool or set of content against which the sample is compared or searched to determine a potential match.

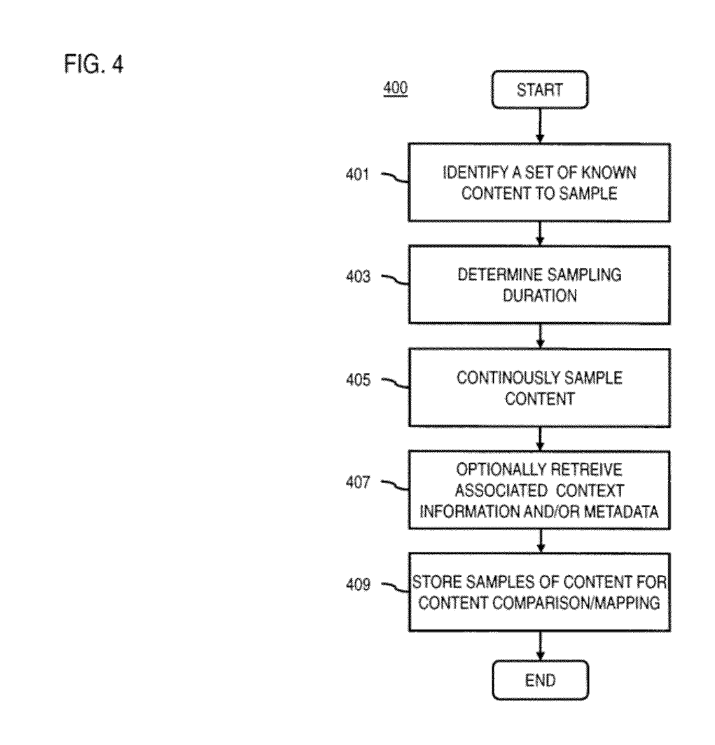

In another embodiment, the content mapping platform 103 may, in addition or alternatively, compare the sample against a database 113 of samples of known content (step 311) to more precisely identify the sample content. The process for creating the database 113 is described in more detail with respect to FIG. 4 below. Once identified, the content mapping platform 103 maps or locates the identified content to one or more sources (e.g., the service platform 115, services 117a-117n, and/or content providers 119a-119m). As noted previously, mapping the content may also include identifying and mapping the sample to related information (e.g., programming description, alternate broadcast times, ratings, recommendations, content type, content name, etc.), other related content (e.g., programs within the same genre, subject matter), marketing information (e.g., advertisements, brochures, etc.).

Per step 313, the content mapping platform 103 then initiates transfer of the mapped content and/or related information or other content to the UE 101. By way of example, the transfer may be provided as a streaming link for access at the UE 101, as a download to the UE 101, as a transmission over any available communication link between the UE 101 and the content source, and/or the like. In addition or alternatively, the content mapping platform may optionally initiate functions, features, applications, and/or services of the UE 101 that are related to the sampled content (step 315). For example, if the sampled content relates to a game, the content mapping platform 103 may execute the game if it is already installed at the UE 101 or may request permission to download or otherwise obtain the game from, for instance, an online application store. In another example, the content mapping platform 103 may initiate a calendar application on the UE 101 to store a calendar entry or reminder about a later broadcast of the identified content or other content that is related to the identified content. In another example, the mapping platform 103 may initiate a word or data processing application on the UE 101 to allow further processing of the content.

This process advantageously enables a user efficiently sample, identify, and then receive content of interest, thereby reducing the burden associated with discovering and accessing content. Thus, the user may have an enhanced experience in accessing and/or discovering content using the approach described herein. The content mapping platform 103 is a means for achieving these advantages.

FIG. 4 is a flowchart of a process for generating a database of content samples for identifying and mapping content, according to an embodiment. In one embodiment, the content mapping platform 103 performs the process 300 and is implemented in, for instance, a chip set including a processor and a memory as shown FIG. 7. In step 401, the content mapping platform 103 identifies a set of known content or content streams to sample. By way of example, the known content or content streams includes, at least in part, live broadcasts, live streams, documents or a combination thereof that are available over the communication network 105 or one or more other broadcast networks. In one embodiment, the content mapping platform 103 may select to collect samples of all or a selected portion of the available content. For example, the content mapping platform 103 may select one or more portions of the available content based, at least in part, on one or more selection criteria. In one embodiment, the selection criteria may include time, location, genre, content type (e.g., streams, downloads, audio, video, etc.), content name, user information, user device information, and/or any other characteristic of the content.

Next, the content mapping platform 103 may select a duration or any other parameter (e.g., quality, bit rate, frequency, etc.) for sampling the known content or content streams (step 403). It is contemplated that the operator of the content mapping platform 103 may select the parameters, for instance, to achieve a balance between resource requirements (e.g., available memory or storage) and extent/quality of the samples collected. For example, in one embodiment, the content mapping platform 103 may select to store only a predetermined duration of each sample (e.g., the last 10 seconds, 20 seconds, 30 seconds, etc.) of each sampled content. In most cases, samples of live content streams will be captured and identified within a relatively short period of time from capture; the content mapping platform 103 need not store an extended duration of each sample of the known content streams.

On selecting the parameters (e.g., parameters) for sampling, the content mapping platform 103 may continuously sample the selected content or content streams according to the selected sampling parameters (step 405). In one embodiment, continuous sampling is performed at, for instance, a predetermined frequency (e.g., 24 times a second, etc.).

In another embodiment, the sampling may be conducted based on a dynamically determined frequency. More specifically, the content mapping platform 103 may determine whether the sample content stream includes fast moving and/or changing characteristics (e.g., a video with a lot of fast movements) and/or if it is a static content. The sampling frequency can then be determined based, at least in part, on the characteristics (e.g., lower frequency for relatively static content and higher frequency for more dynamic content).

As part of the sampling process, the content mapping platform 103 may optionally retrieve or otherwise determine any context information (e.g., time, location) and/or other meta-data (e.g., description, genre, category, rating, etc.) associated with the known content or content streams (step 407). The content mapping platform 103 can then store the samples of the known content and corresponding context information in, for instance, the database 113 of known content samples for comparison and identification of content samples captured according to the process described herein (step 409).

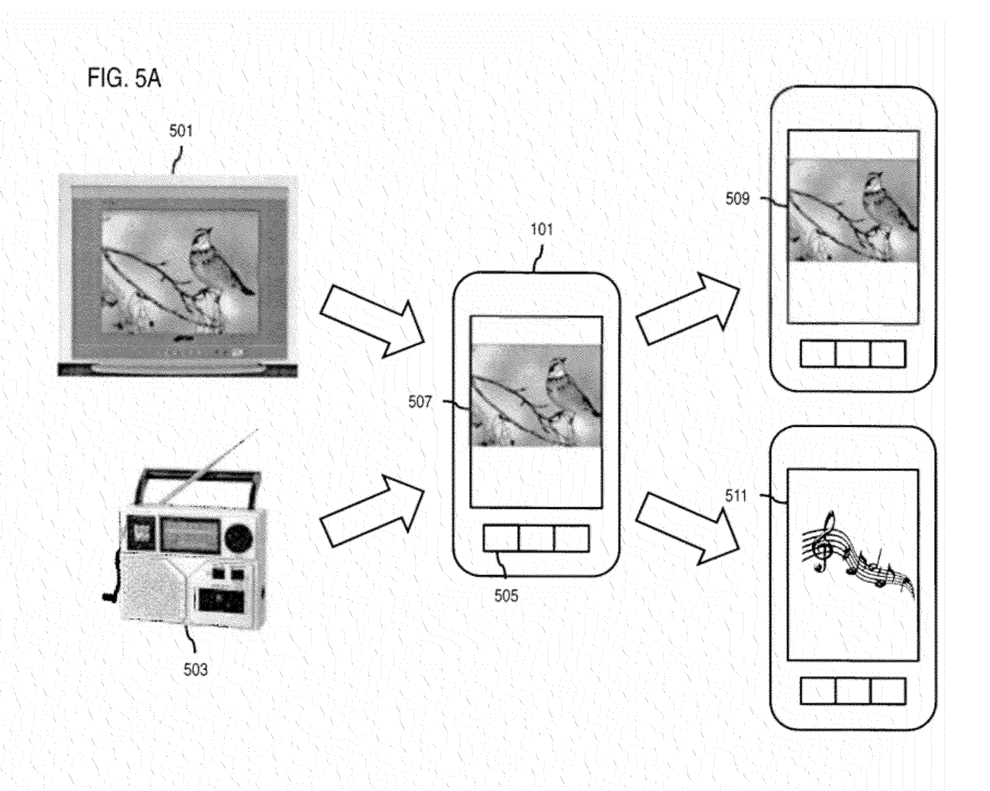

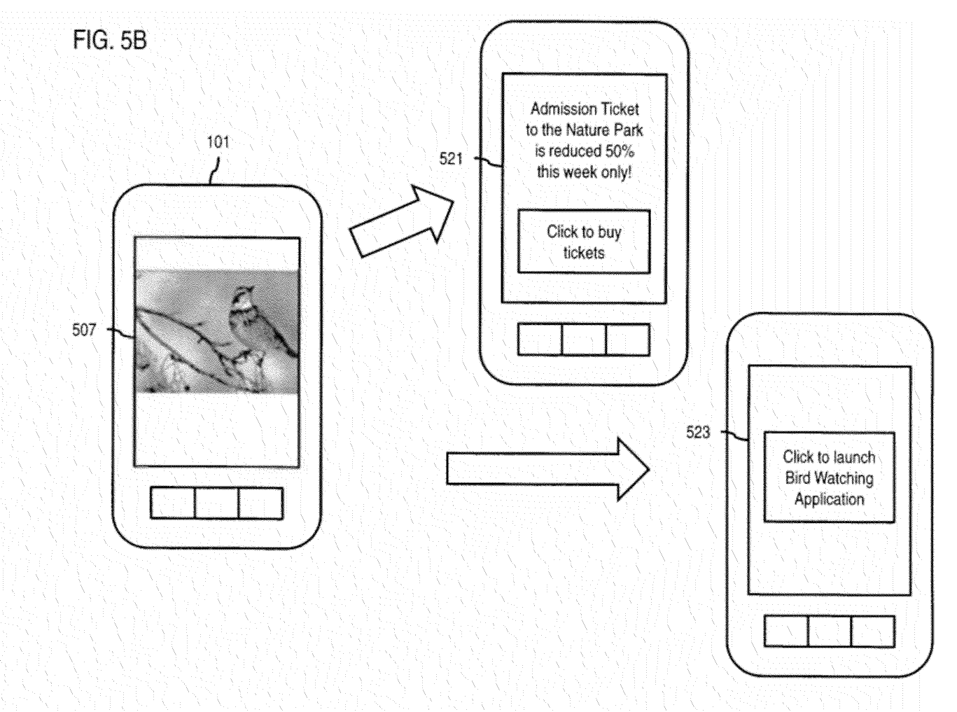

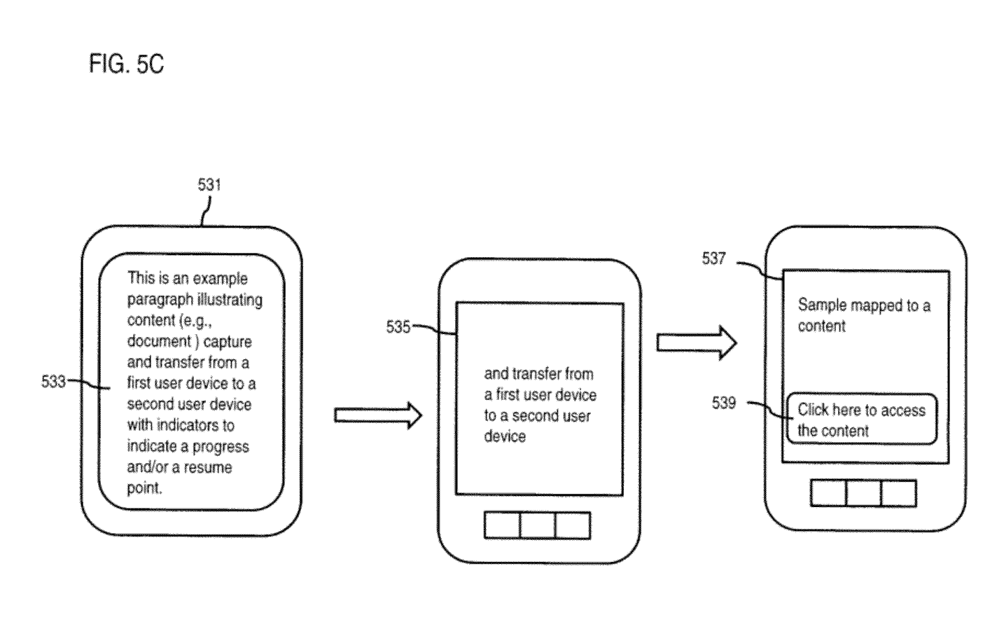

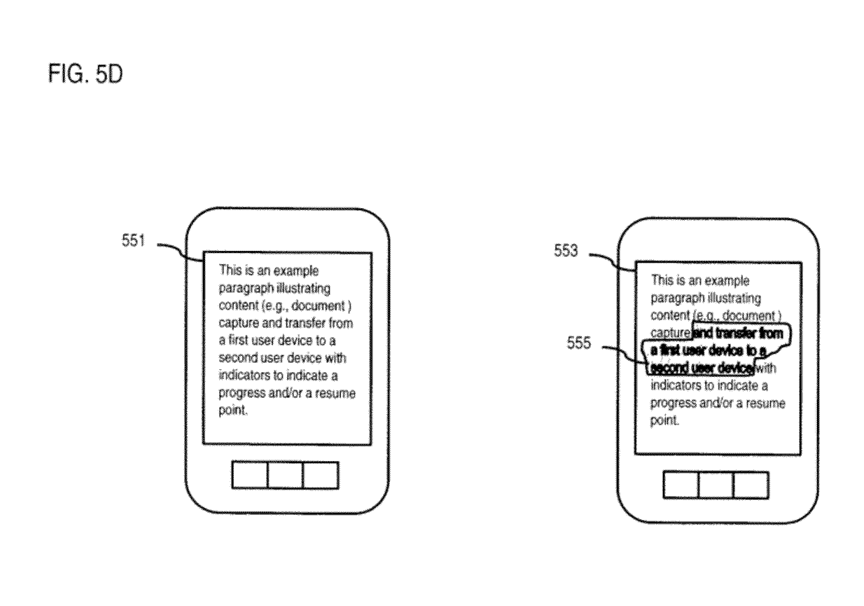

FIGS. 5A-5D are diagrams of user interfaces utilized in the processes of FIGS. 3 and 4, according to various embodiments. As shown in FIG. 5A, content is currently playing on a television 501 and a radio 503. In this example, with respect to the television 501, the content is a live broadcast of a nature program as depicted in the television 501. With respect to the radio 503, the content may be a music track or other audio program. The UE 101 can initiate sampling of either of the television 501 content or the radio 503 content. In one embodiment, the UE 101 may be equipped with a dedicated capture button 505 that invokes a capture application and initiates the identification and mapping process. In addition, the capture application may be a dedicated application for use in the content mapping process (e.g., the content mapping manager 107) or another application (e.g., a camera application) that includes the content mapping function as one of its set of available functions.

On activation of the capture button 505, the UE 101 can capture an image 507 of the content playing on the television 501. It is contemplated that when capturing video content, the sample may include just a single image (e.g., a photograph), a short video clip, an audio only clip, or any combination thereof that may be sufficient for identification. In the case of the content playing on the radio 503, the UE 101 may capture an audio clip of the content. As noted earlier, the audio clip may be of any duration. In addition, in certain embodiments, the UE 101 may capture multiple samples of the same content to facilitate content mapping.

Once the image 507 has been captured, the UE 101 (e.g., via the content mapping platform 103) initiates identification and mapping of the sample by for instance comparison against known content samples and associated content information. On successful identification of the sample, the content mapping platform 103 initiates transmission of the content to the UE 101 which can then continue playing the transferred content at the UE 101 as depicted in user interface 509. Similarly, with a sample of the radio 503, the UE 101 can initiate identification and mapping of the audio sample and receive the audio stream for play back at the UE 101 as depicted in user interface 511.

FIG. 5B-D are diagrams of user interfaces wherein sampled content are mapped to related content, according to various embodiments.

FIG. 5B depicts the UE 101 as described with respect to FIG. 5A that has captured a sample 507 of content playing in the television 501. The sample 507 is provided to the content mapping platform 103 for identification and mapping. In this example, the content mapping platform 103 maps the sample to either other related information or to additional features, functions, or applications. For example, as shown in the user interface 521, the content mapping platform 103 has mapped the sampled content to a related advertisement. In this case, the content mapping platform 103 provides to the UE 101 a screen advertising a reduced ticket prices to a nature park based on identification and mapping of the sample 507 as a nature-related program (e.g., a program about bird watching). In addition or alternatively, the content mapping platform 103 can also provide an option to launch a related application (e.g., a bird watching application to assist in cataloging and identifying birds) on the UE 101 as shown in the user interface 523.

FIG. 5C further depicts the UE 101 as described with respect to FIG. 5A that has captured a sample of content, 533, displaying on the user device screen 531. The sample 535 is provided to the content mapping platform 103 for identification and mapping. In this example, the content mapping platform 103 maps the sample to either other related information or to additional features, functions, or applications. For example, as shown in the user interface 537, the content mapping platform 103 has mapped the sample of the content 533 to content at a cloud computing device. A cloud computing device can be one or more devices at one or more content providers 119, service platforms 115 and/or other storage devices available to system 100. In this example, the content mapping platform 103 presents on the UE 101 a screen indicating a potential match to the content sample has been found and prompts the user to make a selection from one or more options available, for example 539 prompts a choice to access the content. In addition or alternatively, the content mapping platform 103 can provide one or more options such as to launch a related application (e.g., a word or data processing application) to allow utilization of the document, see a preview of the potential matched content. In another embodiment, the content mapping platform 103 can map the content sample to one or more contents at one or more cloud computing devices in which case, the user can be prompted to select from one or more options such as to preview the one or more mapped contents, access the one or more contents and the like. In another embodiment, the system 100 authenticates the user and/or the user in order to grant access to the one or more mapped contents. For example, the authentication can be based on the user information, user device, access data in the one or more mapped content, and the like. Further, the access data in the one or more content can be defined, at least in part, by creator of the one or more content, by one or more administrators of the content, by one or more system 100 servers, by one or more owners of the content, and the like.

FIG. 5D depicts user interface 551 and 553 displaying a mapped content on a user device, such as the UE 101. In one embodiment, 551 utilizes one or more applications on the UE 101 to display the mapped content from the beginning of the content, for example a first page of the document. In another embodiment, 553 utilizes one or more applications on the UE 101 to display the mapped content substantially at the same progress point and/or resume point which was in the sample captured by the UE 101. For example, 555 indicates the progress and/or resume point by textual effects and a highlighted section affecting the captured sample content. In another example where the content is a multi-page document, the page representing the progress point can be identified from the captured sample. The mapped content can then be displayed in another user interface opened to the identified page.

The processes described herein for identifying and mapping content streams may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

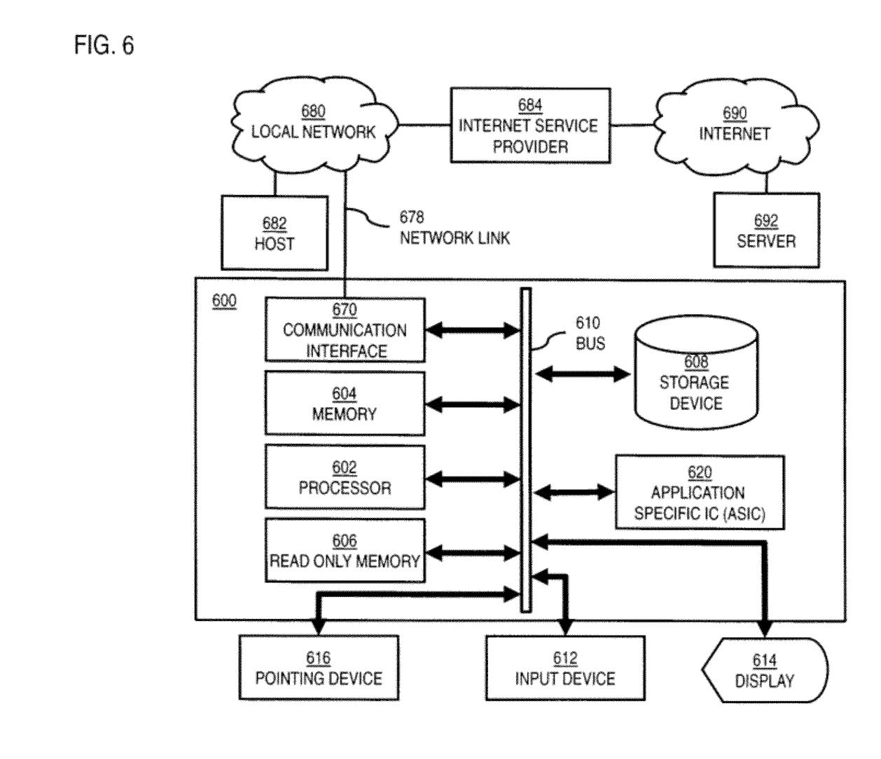

FIG. 6 is a diagram of hardware that can be used to implement an embodiment of the invention. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to identify and map content streams as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of identifying and mapping content streams.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to identifying and mapping content streams. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for identifying and mapping content streams. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for identifying and mapping content streams, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for identifying and mapping content streams.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 is a diagram of a chip set that can be used to implement an embodiment of the invention. Chip set 700 is programmed to identify and map content streams as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of identifying and mapping content streams.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to identify and map content streams. The memory 705 also stores the data associated with or generated by the execution of the inventive steps.

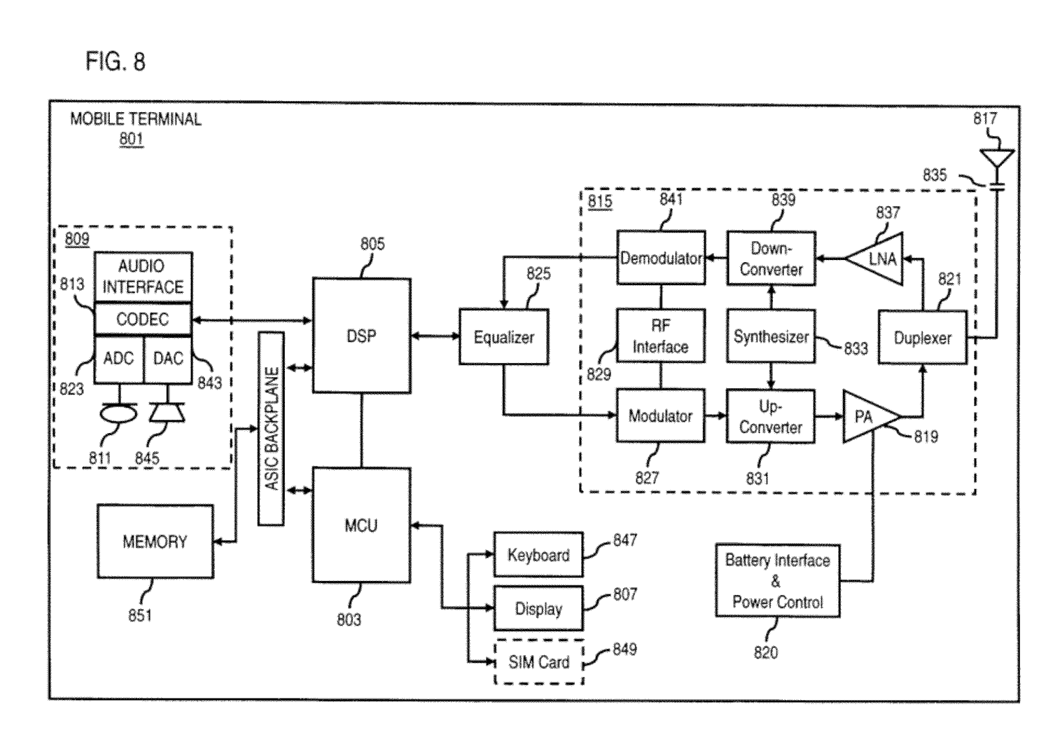

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of identifying and mapping content streams. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of identifying and mapping content streams. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to identify and map content streams. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a sample of content;
determining to identify the content based, at least in part, on the sample; and
determining to initiate transfer of the content, information related to the content, other content related to the content, or a combination thereof to a device based, at least in part, on the identification.

2. A method of claim 1, further comprising:
receiving context information associated with the sample, the device, the content, or a combination thereof,
wherein the identification of the content is further based, at least in part, on the context information.

3. A method of claim 2, wherein the context information includes, at least in part, timestamp information, location information, activity information, content name, or a combination thereof.

4. A method of claim 1, further comprising:
receiving context information associated with the device; and
determining to select from among the content, the information related to the content, the other content related to the content, or a combination thereof based, at least in part, on the context information,
wherein the transfer of the content, the information related to the content, the other content related to the content, or a combination thereof is further based, at least in part, on the selection.

5. A method of claim 1, further comprising:
determining to compare the sample to a content database, the content database storing one or more other samples of known content,
wherein the identification of the content is further based, at least in part, on the comparison.

6. A method of claim 5, wherein the known content includes, at least in part, live broadcasts, live streams, or a combination thereof, and wherein the one or more other samples represent continuous captures of at least one of the live broadcasts, live streams, or a combination thereof over a pre-determined duration.

7. A method of claim 5, wherein the known content includes, at least in part, one or more text documents, data documents or a combination thereof.

8. A method of claim 1, further comprising:
determining a progress point of the content based, at least in part, on the sample;
determining to restore the progress point on transfer of the content to the device.

9. A method of claim 1, further comprising:
determining to initiate a function, an application, a feature, or a combination thereof of the device based, at least in part, on the identification.

10. A method of claim 1, wherein the sample is an image, a video capture, an audio capture, or a combination thereof, and wherein the content is a content stream, content broadcast, or a combination thereof.

11. An apparatus comprising:
at least one processor; and
at least one memory including computer program code for one or more programs,
the at least one memory and the computer program code configured to, with the at least one processor, cause the apparatus to perform at least the following,
receive a sample of content;
determine to identify the content based, at least in part, on the sample; and
determine to initiate transfer of the content, information related to the content, other content related to the content, or a combination thereof to a device based, at least in part, on the identification.

12. An apparatus of claim 11, wherein the apparatus is further caused to:
receive context information associated with the sample, the device, the content, or a combination thereof,
wherein the identification of the content is further based, at least in part, on the context information.

13. An apparatus of claim 12, wherein the context information includes, at least in part, timestamp information, location information, activity information, content name, or a combination thereof.

14. An apparatus of claim 11, wherein the apparatus is further caused to:
receive context information associated with the device; and
determine to select from among the content, the information related to the content, the other content related to the content, or a combination thereof based, at least in part, on the context information,
wherein the transfer of the content, the information related to the content, the other content related to the content, or a combination thereof is further based, at least in part, on the selection.

15. An apparatus of claim 11, wherein the apparatus is further caused to:
determine to compare the sample to a content database, the content database storing one or more other samples of known content,
wherein the identification of the content is further based, at least in part, on the comparison.

16. An apparatus of claim 15, wherein the known content includes, at least in part, live broadcasts, live streams, or a combination thereof and wherein the one or more other samples represent continuous captures of at least one of the live broadcasts, live streams, or a combination thereof over a pre-determined duration.

17. An apparatus of claim 15, wherein the known content includes, at least in part, one or more text documents, data documents or a combination thereof.

18. An apparatus of claim 11, wherein the apparatus is further caused to:
determine a progress point of the content based, at least in part, on the sample;
determine to restore the progress point on transfer of the content to the device.

19. An apparatus of claim 11, wherein the apparatus is further caused to:
determine to initiate a function, an application, a feature, or a combination thereof of the device based, at least in part, on the identification.

20. An apparatus of claim 11, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

21.-46. (canceled)
